(19) United States
(12) Patent Application Publication
(10) Pub. No.: US 2026/0256067 A1
(43) Pub. Date: Sep. 3, 2026

(54) CULTIVATION TROUGH AND TRANSPORT SYSTEM

(71) Applicant: PB TECHNIEK B.V., Maasdijk (NL)

(72) Inventor: Koenraad Hedricus Maria BRABANDER, Maasdijk (NL)

(73) Assignee: PB TECHNIEK B.V., Maasdijk (NL)

(21) Appl. No.: 18/846,757

(22) PCT Filed: Mar. 14, 2023
(86) PCT No.: PCT/NL2023/050126

§ 371 Date: Sep. 13, 2024

(30) Foreign Application Priority Data
Mar. 14, 2022 (NL) 2031269

(51) Int. Cl. A01G 31/04

(52) U.S. Cl. CPC A01G 31/045

(57) ABSTRACT

A cultivation trough includes an elongate receptacle extending in a longitudinal direction and configured to receive one or more of crops, water and substrate. The cultivation trough is configured to be transportable by a transport system in a transport direction transverse to the longitudinal direction of the cultivation trough. The cultivation trough comprises a stabilizer configured to engage with a tilt support of the transport system to stabilize the cultivation trough to prevent tilting thereof. A transport system configured to transport a plurality of cultivation troughs in a transport direction transverse to longitudinal directions of the cultivation troughs. The transport system includes a tilt support configured to engage with one or more of respective stabilizers of each of the plurality of cultivation troughs, to stabilize the cultivation troughs to prevent tilting thereof. A method comprising usage of the cultivation trough and/or transport system.

The present disclosure relates to a cultivation trough and a transport system for such a cultivation trough. Moreover, the present disclosure relates to a method comprising usage of at least one such a cultivation trough and/or transport system.

Cultivation troughs—which are sometimes referred to as cultivation gutters or cultivation gullies—are commonly used in horticultural cultivation systems in greenhouses to accommodate and grow crops. In these horticultural cultivation systems seeds, seedlings or young crops are arranged in respective receptacles of adjacently arranged cultivation troughs. Over the duration of a grow cycle of the crops ending when the crops are ready for harvesting, the cultivation troughs are moved step-wise in a transport direction towards an end of the cultivation system. By the time the crops have fully matured and are ready for harvesting, the cultivation trough in which they are placed will have reached the end of a production line of the cultivation system. The cultivation trough is then removed for harvesting of the crops and cleaning of the cultivation trough, after which the cultivation trough is reseeded and placed back into the cultivation system to reiterate the grow cycle.

In commercial greenhouses, it is desirable to grow crops as efficiently as possible. In part, this is achieved by optimizing the number of crops grown per unit of surface area of the greenhouse, by creating optimal growth conditions for crops and by ensuring that the used cultivation system performs consistently and reliably to minimize any losses in terms of crops and time or resources spent on growing the crops and maintenance of the cultivation system.

The objective of the present invention is to provide a cultivation trough and transport system that are improved relative to the prior art with respect to one or more of the here above aspects.

This objective is achieved with a cultivation trough according to the present invention, comprising at least one elongate receptacle extending in a longitudinal direction and configured to receive one or more of crops, water and substrate, wherein the cultivation trough is configured to be transportable by a transport system in a transport direction transverse to the longitudinal direction of the cultivation trough, and wherein the cultivation trough comprises a stabilizer configured to engage with a tilt support of the transport system to thereby stabilize the cultivation trough to prevent tilting thereof.

In particular, the cultivation trough comprises a stabilizer that is configured to at least partially enclose at least one flange of the transport system, the at least one flange being configured to support the cultivation through, and to engage with a lower surface of the at least one flange, said lower surface defining the tilt support of the transport system, to thereby stabilize the cultivation trough to prevent tilting thereof.

The cultivation trough according to the present invention is advantageously protected against tilting and tipping over, which may occur in particular when the cultivation trough is moved by the transport system or accidentally nudged by a person. As such, losses in terms of time and resource spent rearranging the cultivation trough or damaged crops resulting from this tilting are effectively prevented. In this respect it is remarked that the risk of tipping over increases considerably when the plants grow towards the end of the production line. After all, bigger plants are heavier and they also shift the center-of-gravity of the cultivation trough with plants upwards. A higher center-of-gravity decreases the stability.

In a preferred embodiment of the cultivation trough according to the present invention, the stabilizer comprises one or more than one hook configured to extend along the tilt support of the transport system.

In a further preferred embodiment of the cultivation trough according to the present invention, the one or more than one hook is configured to extend in the longitudinal direction of the cultivation trough.

In a further preferred embodiment of the cultivation trough according to the present invention, the stabilizer is configured to at least partially enclose the tilt support of the transport system.

In a further preferred embodiment of the cultivation trough according to the present invention, the stabilizer comprises a recess configured to receive the tilt support of the transport system.

In a further preferred embodiment of the cultivation trough according to the present invention, the recess is disposed in at least one wall of the cultivation trough.

In a further preferred embodiment of the cultivation trough according to the present invention, the recess is arranged in one or more than one or more than one side wall of the cultivation trough, and a bottom wall of the cultivation trough.

In a further preferred embodiment of the cultivation trough according to the present invention, the stabilizer is arranged at a vertical offset relative to the tilt support of the transport system in at least a non-tilted state of the cultivation trough.

In a further preferred embodiment of the cultivation trough according to the present invention, the cultivation trough further comprises a plurality of stabilizers disposed substantially along a length of the cultivation trough.

In a further preferred embodiment of the cultivation trough according to the present invention, the cultivation trough further comprises a crop accommodation that is arranged asymmetrical relative to a cross section of the cultivation trough. The cross section is transverse relative to the longitudinal direction of the cultivation trough. Consequently, the crop accommodation is arranged at a greater distance from a first longitudinal side wall of the cultivation trough than the distance to a second longitudinal side wall of the cultivation trough, wherein the first and second longitudinal side walls are arranged on opposite sides of the cultivation trough, as well as on opposite sides relative to the crop accommodation. In this way, an enlarged space is provided between the first longitudinal side wall of the cultivation trough and the crop accommodation. This enlarged space allows for more reliable watering of the plants inside the cultivation trough, or a water reservoir defined by this enlarged space inside the cultivation trough. As roots of plants grow naturally towards a water source, having a sole or major water source inside the cultivation trough on one longitudinal side wall of the cultivation trough will cause the root growth to consistently extend into that area, resulting in an asymmetrical weight distribution relative to the cross section of the cultivation through. Most conventional cultivation troughs normally have a substantially symmetrical design in cross section, because an asymmetrical weight distribution may more easily result in a sideward tipping over of the cultivation troughs. The risk of tipping over increases considerably towards the end of the production line of the cultivation system, because the plants grow and thereby become heavier on the one hand, while also shifting the center-of-gravity of the cultivation trough with plants upwards on the other hand. Moreover, due to plant growth, a horizontal offset in the transport direction may be provided or increased between adjacent cultivation troughs to provide physical space of the plants. As a result, neighboring cultivation troughs may not obtain any sideward support from each other anymore. It is however by virtue of the stabilizer that the cultivation troughs according to the present invention are able to apply an advantageous asymmetrical positioning of the crop accommodation relative to the cross section of the cultivation troughs, while at the same time preventing the cultivation troughs against tipping over.

Moreover, because of the increased stability of the cultivation troughs provided by the present invention the width dimensions of the cultivation troughs may be smaller than those of prior-art cultivation throughs without diminishing the stability of the cultivation troughs.

The hereabove objective is further achieved with a transport system according to the present invention, the transport system being configured to transport a plurality of cultivation troughs in a transport direction transverse to longitudinal directions of the cultivation troughs, wherein the transport system comprises a tilt support configured to engage with one or more of respective stabilizers of each of the plurality of cultivation troughs, to thereby stabilize the cultivation troughs to prevent tilting thereof.

In a preferred embodiment of the transport system according to the present invention, the tilt support comprises at least one flange configured to extend along the stabilizer of the cultivation trough.

In a further preferred embodiment of the transport system according to the present invention, the at least one flange substantially extends along the transport system in the transport direction.

In a further preferred embodiment of the transport system according to the present invention, an upper surface of the flange defines a support configured to support the cultivation trough, and a lower surface of the flange defines a tilt support configured to prevent the cultivation trough against tilting.

In a further preferred embodiment of the transport system according to the present invention, the transport system further comprises at least one actuator configured to engage and move each of the plurality of cultivation troughs in the transport direction, wherein the at least one tilt support is arranged adjacent to the at least one actuator.

In a further preferred embodiment of the transport system according to the present invention, the transport system further comprises a plurality of tilt supports disposed substantially along a width direction of the transport system transverse to the transport direction.

The hereabove objective is further achieved by a cultivation system comprising at least one transport system as disclosed herein in combination with, in particular supporting, at least one cultivation through as disclosed herein.

Lastly, the hereabove objective is further achieved with a method for cultivating a crop comprising usage of at least one of the cultivation trough, the transport system and the cultivation system according to the present disclosure.

The present invention will be elucidated further here below with reference to the drawing, in which:

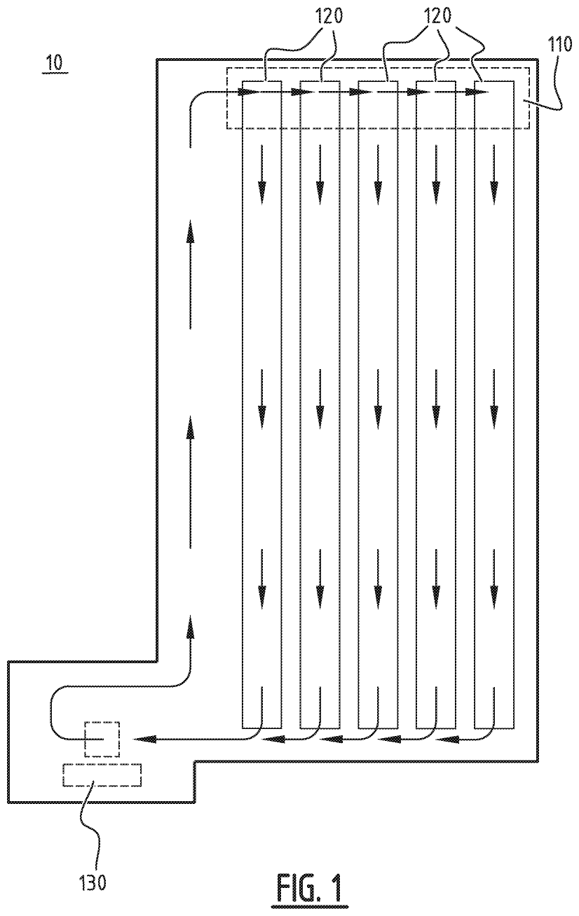

FIG. 1 depicts a schematic top-down view of a cultivation system having a transport system with rows of cultivation troughs;

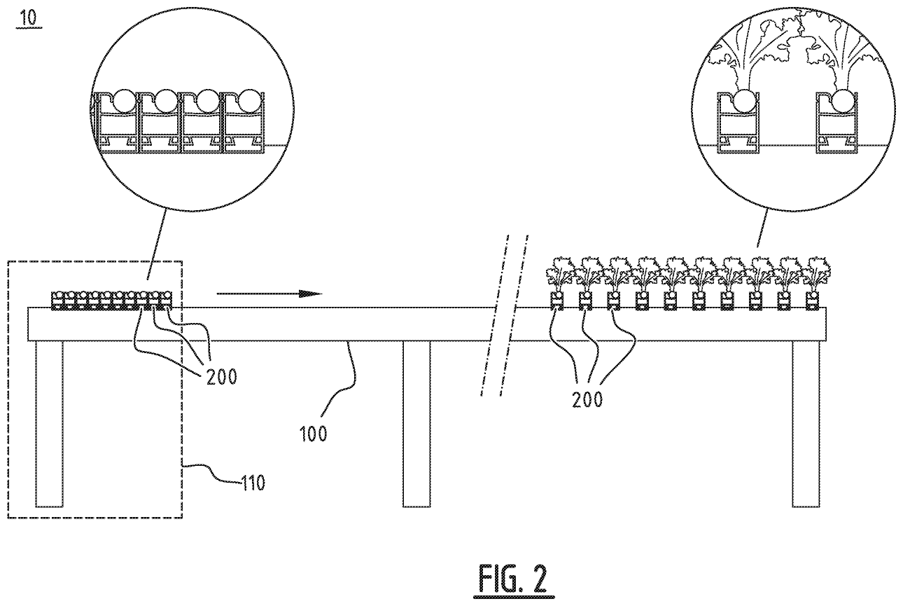

FIG. 2 shows a side view of a row or plurality of cultivation troughs from the cultivation system of FIG. 1;

FIG. 3 shows a cross-section of a cultivation trough according to the present invention;

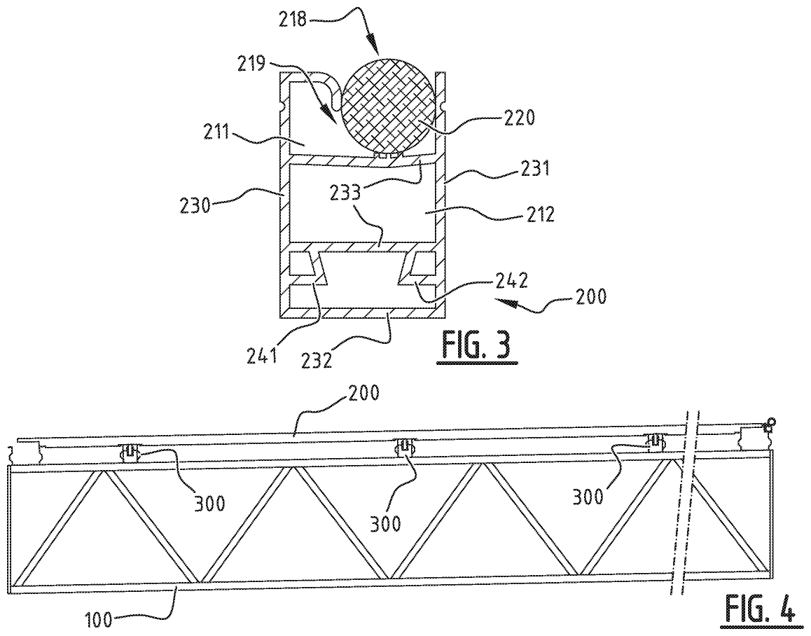

FIG. 4 shows a view of a cultivation trough placed on the transport system when viewed in a direction opposite the transport direction;

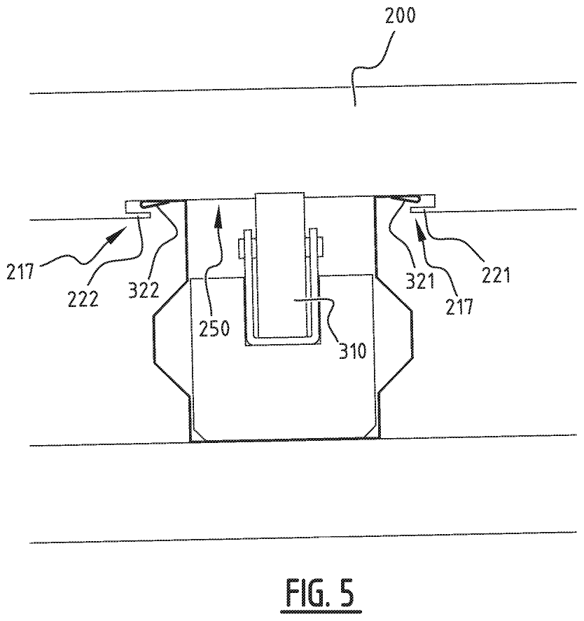

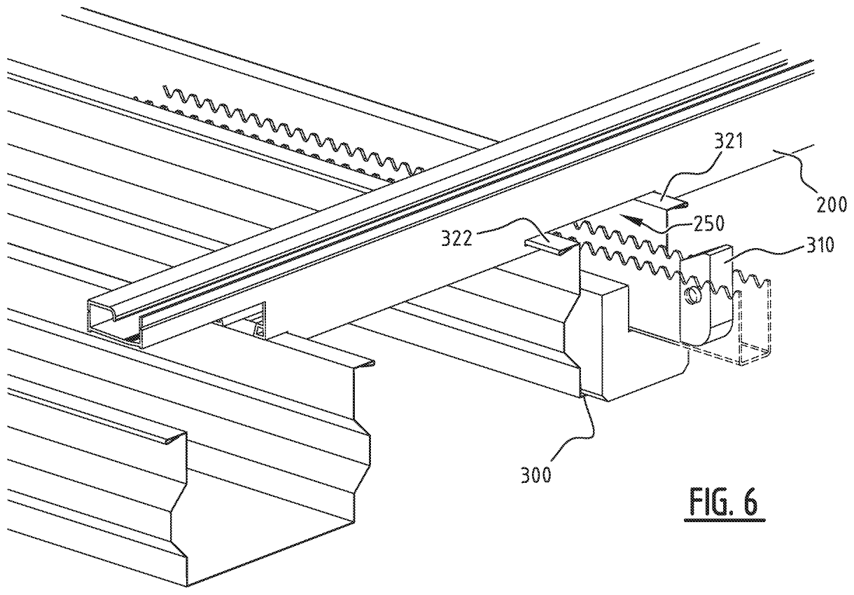

FIGS. 5 and 6 depict a section of FIG. 4 in more detail in, respectively, a frontal view and a perspective view; and

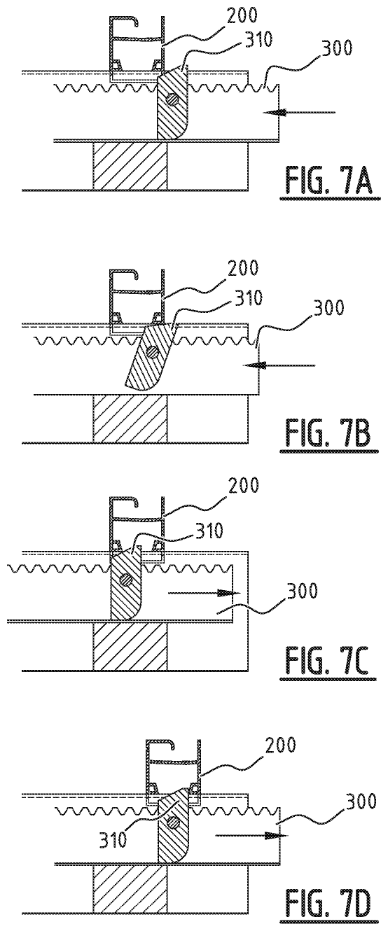

FIGS. 7A to 7D illustrate a process of engaging and transporting the cultivation trough by means of the transport system.

FIG. 1 shows a top-down view of a cultivation system 10 including a transport system 100 placed in a greenhouse. The cultivation system 10 is a rotation cultivation system in that crops are continuously removed therefrom for harvesting and seeds, seedlings or young crops are introduced therein to start their grow cycle.

As can be discerned from FIG. 1 in conjunction with FIG. 2, the cultivation system 10 comprises a plurality of rows 120 of cultivation troughs 200, wherein each cultivation trough 200 comprises crops or plants to be cultivated. The cultivation troughs 200 are disposed parallel to one another with respect to the longitudinal direction to form each row 120. In FIG. 1 five rows 120 of cultivation troughs 200 are depicted, although the present disclosure is not limited thereto and any arbitrary number of rows 120 may be selected.

The cultivation system 10 comprises a germination section 110 at the start of each row 120. In this germination section 110, cultivation troughs 200 with crops at the start of their grow cycle are introduced into the cultivation system 10. At this stage of the grow cycle, the cultivation troughs 200 are arranged in close proximity to one another to optimize usage of the available surface area and—in prior-art cultivation systems—provide stability to one another to prevent the cultivation troughs 200 from tilting and/or tipping over.

Over the course of the grow cycle of the crops, the cultivation troughs 200 are transported from the germination section 110 in a transport direction indicated by the downward arrows in FIG. 2. Because the crops grow in size over the course of the grow cycle, an intermediate distance between subsequent cultivation troughs 200 must be increased over the course of the grow cycle to provide sufficient growth space for each crop. In FIG. 2, this is indicated by the cultivation troughs 200 being disposed closer to one another at the germination section 110 on the left side of FIG. 2 than at an end section on the right side of FIG. 2.

When the crops have completed their grow cycle and are ready for harvesting at the end of the production line of the cultivation system 10, the cultivation troughs 200 are removed from their respective rows 120 at an end section opposite the germination section 110 of the rows 120. The cultivation troughs 200 are then brought to a harvesting section 130 where the crops are harvested and the cultivation troughs 200 are emptied and cleaned. Finally, the cultivation troughs 200 are reseeded and reintroduced into the germination section 110 of cultivation system 10 to start another grow cycle.

FIG. 2 shows a cross-section of the cultivation trough 200 of FIG. 2. The cultivation trough 200 comprises at least one elongate receptacle 219 extending in a longitudinal direction of the cultivation trough 200. The elongate receptacle 219 is configured to receive one or more of crops, water and optionally substrate if a substrate-based cultivation method is used.

The cultivation trough 200 shown in FIG. 3 comprises a first longitudinal side wall 230 and a second longitudinal side wall 231 that are connected to each other via a bottom wall 232 and one or more than one intermediate wall 233 that increase the stiffness to the cultivation trough 200. The intermediate wall 233, and more in particular an upper intermediate wall 233 in case of more than one intermediate wall 233, may support a substrate 220 for growth of the crop. Parts of the first longitudinal side wall 230 and the second longitudinal side wall 231 extend upward relative to the (upper) intermediate wall 233 and mutually define a receptacle 219. This receptacle 219 defines a crop accommodation 218 that is arranged asymmetrical relative to the cross section of the cultivation trough 200. In FIG. 3, the crop accommodation 218 that comprises the substrate 220 is arranged at a greater distance from the first longitudinal side wall 230 than the distance to the second longitudinal side wall 231. As a result, a root and watering area 211 is formed between the substrate 220 and the first longitudinal side wall 230, allowing for a reliable watering of the roots of the crops that will naturally grow towards and into this root and watering area 211. The asymmetrical positioning of the crop accommodation 218 and substrate 220, the root and watering area 211 may be large relative to the total width defined between the first longitudinal side wall 230 and the second longitudinal side wall 231 of the cultivation trough 200. This allows for sufficient space for introducing water into the root and watering area 211, while also allowing the total width of the cultivation trough 200 to be relatively small. The width of the cultivation trough 200 determines how many cultivation troughs 200 may be accommodated in the cultivation system 10. The cultivation trough 200 moreover comprises first and second protrusions 241 and 242, which are arranged on the first longitudinal side wall 230 and the second longitudinal side wall 231, respectively. These protrusions 241, 242 are configured to be engaged by a member 310 of an actuator 300 of the transport system 100 to move the cultivation trough 200 in the transport direction as described hereabove. The member 310 of the transport system 100 may reach the first and second protrusions 241, 242 via a recess 250 that is not shown in the cross section of the cultivation trough 200 depicted in FIG. 3, but will be elucidated here below with reference to FIG. 5 and FIG. 6.

FIG. 4 shows a cultivation trough 200 in conjunction with the transport system 100. As can be discerned from this figure, the transport system 100 comprises one or more actuators 300 configured to engage and move each of the plurality of cultivation troughs 200 in the transport direction. The actuators 300 are disposed at locations that respectively correspond to the locations of stabilizers 217 of the cultivation trough 200.

In FIG. 5 a detailed view of one of the actuators 300 of FIG. 4 engaging a cultivation trough 200 is depicted. As can be discerned from FIG. 5, the cultivation trough 200 comprises a stabilizer 217 in the form of a recess 250 where the side wall 231 and the bottom wall 232 have been partially removed to define a first hook 221 and a second hook 222.

The actuator 300 comprises a pivotable member 310 configured to extend into the recess 250 and abut the first and/or second protrusions 241, 242, to thereby move the cultivation trough 200 in the transport direction. The interaction between the pivotable member 310 and the first and second protrusions 241, 242 during transport of the cultivation trough 200 will be further elucidated here below with reference to FIGS. 7A to 7D.

The recess 250 extends over a longer distance in the side wall 231 than in the bottom wall 232, to thereby define a first hook 221 and a second hook 222. More in particular, the first hook 221 and a second hook 222 may constitute hooks configured to extend along respective tilt supports 321, 322 of the transport system 100, preferably in at least the longitudinal direction of the cultivation trough 200 that is transverse to the transportation direction.

Still referring to FIG. 5 and moreover FIG. 6, the transport system 100 comprises a first tilt support 321 and a second tilt support 322 configured to engage with the first hook 221 and the second hook 222 of the cultivation trough 200, respectively. In particular, the tilt support 321 and a second tilt support 322 may each constitute a flange configured to extend along the stabilizer 217 of the cultivation trough 200, and to be at least partially enclosed thereby.

Within the context of the present invention as disclosed herein, the stabilizer 217 of the cultivation trough 200 may refer to any one or more of the recess 250, the first hook 221 and the second hook 222.

Each of the flanges constituting the first tilt support 321 and the second tilt support 322 comprises an upper surface and a lower surface. The respective upper surfaces of the first and second tilt supports 321, 322 are configured to support the cultivation trough 200 when the cultivation trough 200 is arranged upon and/or transported by the transport system 100. When the cultivation trough 200 is inclined to tilt—which may occur in particular during transport or when the cultivation trough is nudged—the respective lower surfaces of the flanges constituting the first tilt support 321 and the second tilt support 322 respectively contact the first hook 221 and the second hook 222, thereby preventing the cultivation trough 200 from tilting.

With the cultivation trough 200 and the transport system 100 according to the present invention, an accidental tilting of the cultivation trough 200 is effectively prevented over the entire duration of the grow cycle of the crops. The costs associated with a cultivation trough 200 tilting—which may include having to rearrange the cultivation trough 200 or even having to replace its contents—is thereby likewise avoided.

In prior-art cultivation troughs, the width of the cultivation trough has to be sufficiently large to provide a sufficiently large footprint to thereby stabilize the cultivation trough. With the increased stability provided by the cultivation trough 200 and transport system 100 according to the present invention, this is no longer required and the width of the cultivation trough 200 may be further reduced. As such, the available surface area for cultivating crops may be utilized more efficiently with a greater number of cultivation troughs 200 being placed thereon.

Furthermore, the increased degree of stability of the cultivation trough 200 and the transport system 100 according to the present invention allows for further modifications of the design of the cultivation trough 200 that are not attainable with prior-art cultivation troughs because they would result in the cultivation trough being unstable. In FIG. 3, a substrate 220 that is arranged in the crop accommodation 218 of the elongate receptacle 219 is offset relative to the (dotted) center line of the cultivation trough 200 (FIG. 3); with the root and watering area 211 accommodating the roots of the crops being positioned asymmetrical, i.e. closer to the second longitudinal side wall 231 than to the first longitudinal side wall 230. Typically, water is supplied to the root and watering area 211 at only one side thereof. Here, the crop will primarily develop water roots with which the crop absorbs water. At a side where no water is supplied, the crop will generally not develop roots. Instead, the crop may primarily develop air roots at this side with which it may absorb air.

A process of transporting a cultivation trough 200 by means of the transport system 100 will now be described with reference to FIG. 7A to FIG. 7D.

In FIG. 7A, an actuator 300 of the transport system 100 having arranged thereon a pivotable member 310 is displaced in the direction of the arrow towards a cultivation trough 200 to be transported. The pivotable member 310 comprises a chamfered top and pivots to slide past the second longitudinal side wall 231 upon contact with the cultivation trough 200 as is illustrated in FIG. 7B.

In FIG. 7C, the pivotable member 310 has slid past the second longitudinal side wall 231 and pivoted back into its resting position to protrude into the recess 250 of the cultivation trough 200. The pivotable member 310 may connected with a spring (not shown) or comprise a weighted lower section for this purpose. Upon reassuming its resting position, the pivotable member 310 is retracted in the direction of the arrow in FIG. 7C.

In FIG. 7D, the pivotable member 310 contacts the first or second protrusion 241, 242 as it is retracted in the direction of the arrow (i.e. the transport direction). Because the pivotable member 310 is configured to be not rotatable in the counter-clockwise direction relative to its resting position, the pivotable member 310 catches the cultivation trough 200 and displaces it in the transport direction until it reaches a desired location.

The cultivation trough 200 according to the present invention may, for example, be manufactured by extruding a material including any suitable type of plastic or metal. The stabilizer 217 including any one of the recess 250, the first hook 221 and the second hook 222, and combinations thereof, may be manufactured by local milling of any excess material.

Moreover, it is conceivable that the first hook 221 and the second hook 222 are alternatively embodied by separate members distinct from a main body of the cultivation trough 200, that are attached to the main body of the cultivation trough 200 during a manufacturing process.

It is emphasized here that the scope of protection for the developments described in the present disclosure are by no means limited to any particular feature of the embodiments described above and illustrated in the appended drawing. The scope of protection is exclusively determined based on the limitations of the appended independent claims, but may, in some jurisdictions, even encompass obvious alternatives for features in the independent claims.

Other variations for specifically described elements, components and functionalities, that may also be embodied within the scope of the appended claims of the present disclosure, have been at least hinted at in the above embodiment description or the skilled person may be considered to be able to contemplate these variations within the range of this skilled person's general knowledge. This exemplary reference to alternative embodiments substantiates that any limitation to any specific feature, that is not defined as a limitation in the independent claims, is unwarranted.

1. A cultivation trough comprising at least one elongate receptacle extending in a longitudinal direction and configured to receive one or more of crops, water and substrate;
wherein the cultivation trough is configured to be transportable by a transport system in a transport direction transverse to the longitudinal direction of the cultivation trough and to be supported by an upper surface of at least one flange of the transport system, and
wherein the cultivation trough comprises a stabilizer configured to at least partially enclose the at least one flange of the transport system and to engage with a lower surface of the at least one flange defining a tilt support of the transport system to thereby stabilize the cultivation trough to prevent tilting thereof.

2. The cultivation trough according to claim 1, wherein the stabilizer comprises one or more than one hook configured to extend along the tilt support of the transport system.

3. The cultivation trough according to claim 2, wherein the one or more than one hook is configured to extend in the longitudinal direction of the cultivation trough.

4. The cultivation trough according to claim 1, wherein the stabilizer comprises a recess configured to receive the tilt support of the transport system.

5. The cultivation trough according to claim 4, wherein the recess is disposed in at least one wall of the cultivation trough.

6. The cultivation trough according to claim 5, wherein the recess is arranged in one or more than one side wall of the cultivation trough.

7. The cultivation trough according to claim 5, wherein the recess is arranged in a bottom wall of the cultivation trough.

8. The cultivation trough according to claim 1, wherein the stabilizer is arranged at a vertical offset relative to the tilt support of the transport system in at least a non-tilted state of the cultivation trough.

9. The cultivation trough according to claim 1, comprising a plurality of stabilizers disposed substantially along a length of the cultivation trough.

10. The cultivation trough according to claim 1, further comprising a crop accommodation that is arranged asymmetrical relative to a cross section of the cultivation trough.

11. A transport system configured to transport a plurality of cultivation troughs in a transport direction transverse to longitudinal directions of the cultivation troughs, wherein the transport system comprises at least one flange configured to extend along and engage with one or more of respective stabilizers of each of the plurality of cultivation troughs, to thereby stabilize the cultivation troughs to prevent tilting thereof, wherein:
an upper surface of the at least one flange defines a support configured to support the cultivation trough; and
a lower surface of the at least one flange defines the tilt support configured to prevent the cultivation trough against tilting.

12. The transport system according to claim 11, wherein the at least one flange substantially extends along the transport system in the transport direction.

13. The transport system according to claim 11, further comprising at least one actuator configured to engage and move each of the plurality of cultivation troughs in the transport direction, wherein the at least one tilt support is arranged adjacent to the at least one actuator.

14. The transport system according to claim 11, further comprising a plurality of tilt supports disposed substantially along a width direction of the transport system transverse to the transport direction.

15. A cultivation system comprising at least one transport system configured to transport a plurality of cultivation troughs in a transport direction transverse to longitudinal directions of the cultivation troughs, wherein the at least one transport system comprises at least one flange configured to extend along and engage with one or more of respective stabilizers of each of the plurality of cultivation troughs, to thereby stabilize the cultivation troughs to prevent tilting thereof, wherein an upper surface of the at least one flange defines a support configured to support the cultivation trough, and a lower surface of the at least one flange defines the tilt support configured to prevent the cultivation trough against tilting; and
at least one cultivation trough according to claim 1 supported by the at least one transport system.

16. A method for cultivating a crop, the method comprising using at least one of:
the cultivation trough according to claim 1, wherein one or more of crops, substrate and water are received in the elongate receptacle of the cultivation trough.

17. A method for cultivating a crop, the method comprising using the transport system according to claim 11 supporting a cultivation trough having one or more of crops, substrate and water received in the cultivation trough.

18. A method for cultivating a crop, the method comprising using the cultivation system according to claim 15, wherein one or more of crops, substrate and water are received in the elongate receptacle of the cultivation trough.
